(19) United States
(12) Patent Application Publication
(10) Pub. No.: US 2008/0113710 A1
(43) Pub. Date: May 15, 2008

(54) Electronic gaming device and method

(76) Inventor: Darryl Hughes, River Forest, IL (US)

Correspondence Address: Bryan Charles Wallace, Suite 2100, 203 N. LaSalle, Chicago, IL, 60601, US

(21) Appl. No.: 11/598,865

(22) Filed: Nov. 13, 2006

(51) Int. Cl. G06F 17/00

(52) U.S. Cl. 463/16; 463/25

(57) ABSTRACT

The gaming device of the present invention provides a gaming device having a bonus round. The bonus round enables a player the opportunity to win an award equal to a percentage of the value of credits and/or money that the player has lost during the base gaming sequence.

### FIELD OF THE INVENTION

The present invention relates in general to an electronic gaming device and method, and more particularly to an electronic gaming device having a bonus game feature and method for enabling a player to win a percentage the credits lost during a base game play sequence.

### BACKGROUND OF THE INVENTION

Electronic gaming devices are generally known in the art. Some electronic gaming devices are used in a casino or online casino environment enabling a player to wager bets to win and/or lose money during a play sequence. Typical electronic gaming devices have a display processor connected to a screen display for randomly displaying normal indicia in a grid—line format. The player makes selections based on the icons or indicia displayed on the screen display. Typically the icons are randomly generated by a controller and are compared to the player's selections to determine whether the player has won or lost during that particular play sequence. One such example of this is the electronic game shown in U.S. Pat. No. 6,089,977 to Bennett, which discloses a machine with a pre-formatted grid of icons shown on a screen display. The player makes selections along the grid of cells before the initial play sequence. Random icons are generated during play, which are then compared to the player selected icons to determine whether or not the player is a winner.

Electronic gaming devices having bonus round features with a player selection components are also generally known in the art. U.S. Pat. No. 6,979,263 to Baerlocher et al. discloses a gaming device having a bonus round feature wherein the player either wins that of which the player does not select during the bonus round or the player selectively replaces one award with another award with the hopes of maximizing an ultimate award.

In general, electronic gaming devices are interconnected to a series of gaming devices throughout a location and in electronic communication with each other such that the winnings and losses of all of the connected games are cumulatively accounted and mathematically factored together as a progressive. As such, the winnings and losses of the cumulative games used to randomly generate winning combinations on all of the games, based on the cumulative wins and losses of all of the games as a collective.

Indeed, the aforementioned electronic gaming devices are adequate for their intended purposes, however, none of the prior art inventions disclose an electronic gaming device and method wherein the player has the opportunity to win the award in the bonus game sequence equal to the value or percentage of the accrued value of lost credits during the primary play sequence, as disclosed in the present invention. Furthermore, none of the prior art inventions disclose an electronic gaming device wherein each independent device is its own progressive and the win and lose mathematical random determinations are solely dependant on the player's performance on that individual gaming device.

### SUMMARY OF THE INVENTION

The gaming device of the present invention provides a device having a bonus round and method which provides the player with a plurality of choices, symbols, or indicia relating to a theme of the gaming device. Each of the choices masks an award. The gaming device comprises a loss counter for cumulating the values lost during a base play sequence. The device further comprises a first bonus play sequence comprising a first outcome set. The gaming device further comprises a second bonus play sequence comprising a second selection group having a plurality of second selections, wherein the outcome of the second selections enable a user to win the cumulated values of the loss counter.

In the present embodiment, the first selection group comprises a series of icons activated and deactivated by the player's touch to a display screen. Predetermined award values and outcomes enable the player to enter the second bonus play sequence. The second bonus play sequence comprises as series of icons concealing randomly generated values. The loss counter serves as a progressive such that the values generated by the loss counter are considered in determining future outcomes by a random outcome generator. The series of icons reveal randomly generated values enabling the player to win values equal to that accumulated on the loss counter. In another embodiment, the series of icons comprise an array twenty icons displayed on the video display enabling player selection of said icons. The icons are money bags concealing randomly generated values.

### BRIEF DESCRIPTION OF THE DRAWINGS

Other advantages of the present invention will be readily appreciated as the same becomes better understood by reference to the following description when considered in connection with accompanying drawings wherein:

FIG. 1 is a perspective view of an electronic gaming device in accordance with the present invention;

FIG. 2 shows a schematic block diagram of the controller used for controlling the gaming device;

FIG. 3 is a front elevation view an example of a screen display of gaming device;

FIG. 4 is a flow chart illustrating one example of a base game play sequence;

FIG. 5 is a flow chart illustrating one example of a first bonus round play sequence;

FIG. 6 is a flow chart illustrating one example of a second bonus round play sequence; and

FIG. 7 illustrates a front elevation view of an example of the screen display illustrating a second bonus round play sequence.

While the present invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

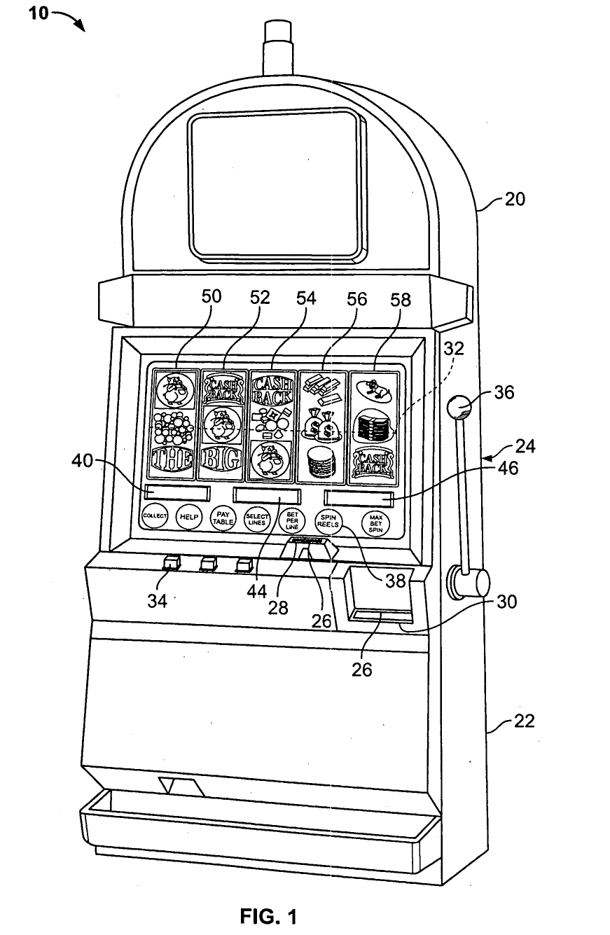

Referring now to the drawings, wherein like numerals indicate like or corresponding parts throughout the several views, and in particular FIG. 1 generally illustrates an electronic gaming device 10, in accordance with the present invention. In the present invention, the electronic gaming device 10 is implemented as a system controller 12, however, it is also contemplated that the gaming device 10 may be implemented as a dedicated hardware circuit, an appropriately programmed general purpose computer, a Personal Digital Assistant (PDA), or any other equivalent electronic, mechanical or electromechanical device, generally known to those skilled in the art.

As shown in FIG. 1, the gaming device 10 generally comprises a housing 20 having a main body 22. In the preferred embodiment, the housing 20 is positioned in a generally upright position, as shown in FIG. 1, however, it is also contemplated that the gaming device 10 and housing 20 may also be configured in a pub-style or table-top game (not shown) such that the housing 20 is positioned in a generally horizontal position, with departing from the scope of the present invention.

The electronic gaming device 10 further comprises an electronic slot machine 24 connected to the main body 22, having controls, displays, and features of an electronic slot machine 24, which will be discussed further herein. As seen, the gaming device 10 comprises one or more a payment interfaces, which can positioned on the main body 22 and configured for accepting money and/or credits from a player to activate game play. As shown in FIG. 1, the payment interface may be a coin slot 26, configured for receiving coins, tokens or credits, and/or it can be a cash payment device 30, configured for receiving paper currency, or both if desired. In addition, the payment interface may comprise a reader or scanner device for the detection of credit cards, debit cards, smart cards, tickets, infrared devices, or the other such devices used for receiving money or credits generally known to those skilled in the art. The payment interface is an input device which is electronically connected to the system controller 12, enabling electronic communication.

The gaming device 10 further comprises a screen display 32. In the present embodiment, the screen display 32 is an interactive screen display 32 comprising a touch sensitive-display screen, generally known to those skilled in the art. The touch-sensitive display screen display 32 is capable of detecting a player's touch on the screen 32 at the location of contact on the screen 32. This enables the player to use the screen display 32 to make selections and/or choices by touching the screen display 32. The screen display 32 may further include a game initiation interface 34 for enabling play initiation to be made by the player by touching the screen 32. The game initiation interface 34 can be any sort of device enabling a user to initiate play, such as a pulling arm 36, or an activation button 38, or both. The game initiation interface 34 is in communication with the system controller 12, therein providing indication to the controller 12 when the player to initiates a play sequence on the gaming device 10 by the user.

The screen display 32 is configured for displaying a series of game playing icons or elements. The gaming elements are preferably displayed in a generally grid-line format, which will be further described later herein.

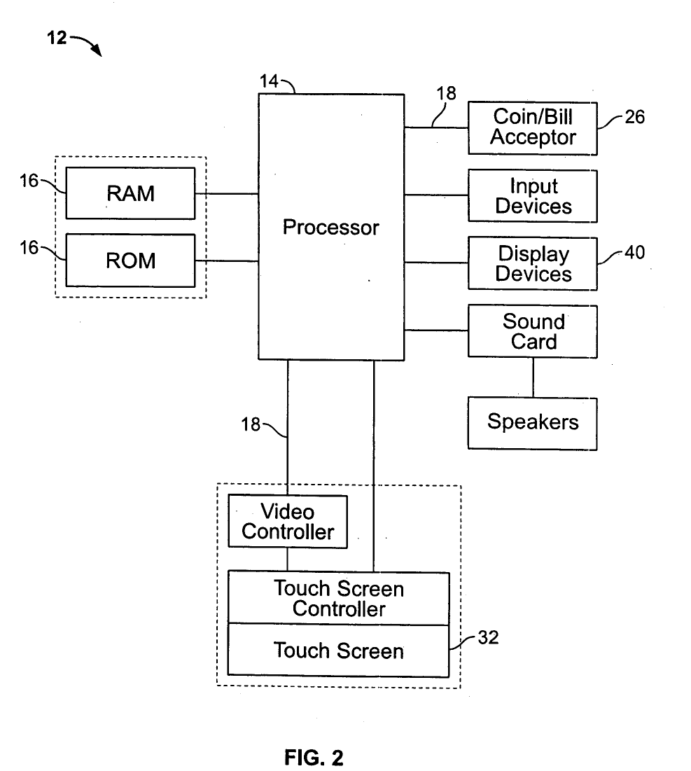

The controller 12 generally comprises a processor 14, as shown in FIG. 2. The processor 14 is in communication with memory device 16 and communication ports 18. It should be appreciated, however that the processor 14 and memory device 16 are preferable implementations of the present invention, which can also be implemented using one or more application-specific integrated circuits (“ASIC's”) or other hardwired devices, or using mechanical devices. Furthermore, although in this embodiment the processor 14 and memory device 16 preferably reside on the gaming device, it is possible to provide some or all of their functions at a central location such as a central server (not shown) for communication to a playing stating over a local area network (LAN) or wide area network (WAN), internet connection, microwave link and the like. Such systems are also referred herein as a processor 14. In one embodiment of the gaming invention, the controller 12 is suitable for operating to initiate a game entitled THE BIG CASH BACK™ which as a musical theme game. THE BIG CASH BACK™ is a trademark of Hughes Who Productions, Inc., Chicago, Ill., used with permission by the assignee of the present invention.

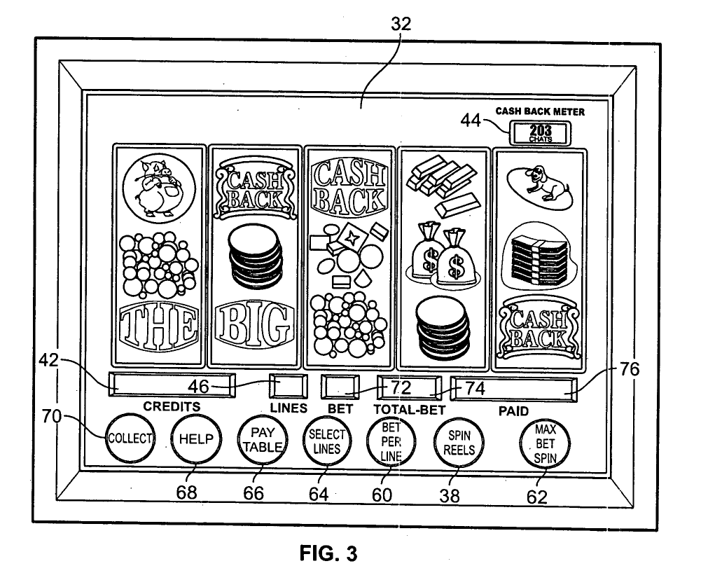

As shown on FIGS. 1 and 3, THE BIG CASH BACK™ game feature is a game in the form of a slot machine having five simulated spinning reels (50-58) shown on the screen display 32. The screen display 32 randomly displays a series of icons along those reels. In the present embodiment, the reels (50-58) display a series of icons related to THE BIG CASH BACK™. Notably, it is appreciated, that the gaming device 10 may be implemented with games, other than the THE BIG CASH BACK™ and/or other alternative game themes without departing from the scope of the present invention.

As shown, THE BIG CASH BACK™ basic game is implemented on the video display 32 showing five randomly simulated spinning wheels 50, 52, 54, 56, and 58 with fifteen pay lines outcomes stored by the controller 12. Each reel has a plurality of symbols such as gold bars, silver dollars, gems, diamonds, stacks of money, money bags, pay back hogs, “The BIG CASH BACK” logo, and etc. that preferably correspond to the theme of the slot machine. Notably, it is contemplated that in the present embodiment that the number of reels may vary, as well as the number of pay lines, without departing from the scope of the present invention.

The gaming device 10 further comprises a credit/award counter 40. The credit counter 40 displays the value of credits available for play as calculated by the processor 14. Credit values are determined by the value of currency deposited in device 10. The credit values have a monetary value which may be cashed out during play sequence. The credit counter 40 is in connection with the system controller 12. In accordance with the present embodiment, the credit counter 40 is displayed generally on the screen display 32, as shown in FIG. 2, however, it is contemplated that the credit counter 40 may also be displayed separately on the body 22 of the gaming device 10, as a completely separate element, without departing from the scope of the present invention.

The present invention further includes a loss meter 44, which accordance with this invention is also referred as a BIG CASHBACK METER™. The meter 44 is in communication with the system controller 12 and processor 14. In one embodiment, the meter 44 displays a percentage of the total value of credits or money lost by the player during base game play sequence. In one embodiment, the processor 14 sets the meter 44 at zero each time a new player activates game play. In another embodiment, the processor 14 calculates the total value of lost credits and does not reset the meter 44 back to zero until a basic game sequence or bonus round sequence triggers payout of the credit value displayed on meter 44.

The gaming device 10 further comprises a line meter 46. The line meter 46 indicates how many pay line combinations the player has selectively wagered in the basic game play sequence. Pay lines are generally defined as winning outcomes displayed as icon arrangements across the rows and columns of the reels (50-58). The player wins credits when a play sequence randomly generates an outcome, appearing in the form of an icon arrangement, that matches predetermined winning icon arrangements (i.e. winning pay line outcomes) as stored by the controller 12.

The gaming device 10 further includes a bet per line meter 60, which displays a value that the player has wagered on each pay line (i.e. winning icon arrangement). The total bet meter 62 displays the cumulative value of credits bet per that particular play sequence. In accordance with the present embodiment, the values for the line meter 46, bet meter 60 and total bet meter 62 are displayed as images on the screen display 32 as shown, however notably, it is further contemplated that these elements may be shown external to the screen display 32 as separate elements, without departing from the scope of the present invention.

The controller 12 executes the programmed game, which signals the counter to display the value of credits played. In this embodiment, upon execution, the THE BIG CASH BACK™ game is initiated. System memory 16 stores control software, operational instructions, and data associated with the gaming device 10. In one embodiment, the memory device 16 comprises a separate ROM. However, it will be appreciated that the system memory 16 may be implemented on any of several alternative types of member structures. In addition, the system memory 16 stores various winning outcomes for base game play, bonus round game play, second bonus round game play and triggering outcomes for the first bonus round and second bonus round. A pay off mechanism is operable in response to instructions from the controller 12 to award a payoff of coins or credits to the player in response to matching winning outcomes.

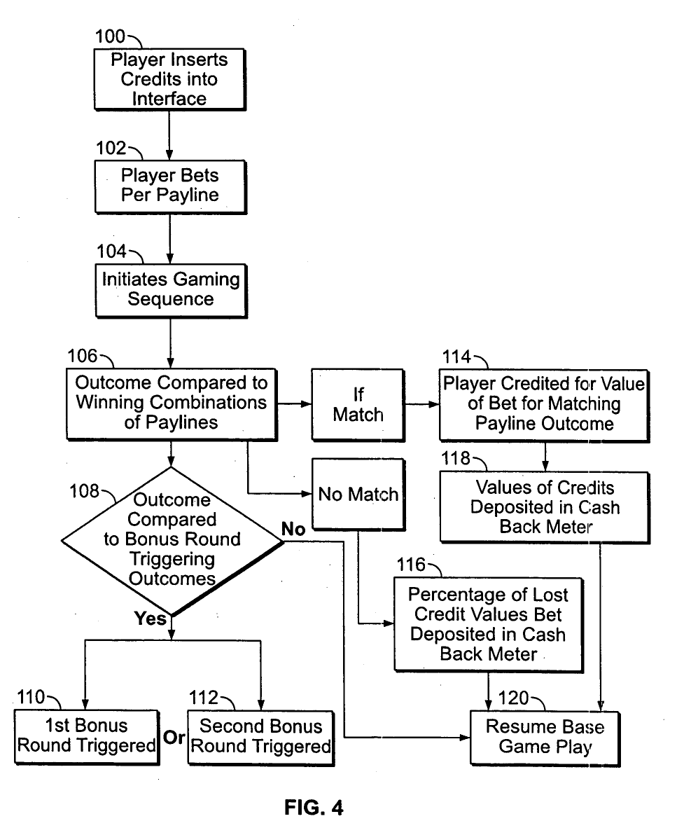

FIG. 4 is a flow chart diagram illustrating one example of the base game play sequence of THE BIG CASH BACK™ as implemented on the gaming device 10 in accordance with present invention. As shown, the base game play sequence of the BIG CASH BACK™ game is initiated when the player activates the payment interface by depositing or transferring a requisite value of money, currency or credits to the gaming device 10. As previously indicated, currency can comprise of coins, dollars or electronic credits generally suitable for the payment interface and device 10. Once the requisite value of credits has been received by the device 10, a signal is sent to the controller 12 and processor 14, and a credit value is credited to the player, which is displayed on the credit counter 42. The controller 12 then activates a switch enabling the base game play sequence to begin. Notably, the minimum credit value required to commence can be varied, as programmed.

The gaming device 10 prompts the player to wager credits on one or more potential pay line outcomes. As previously stated, pay line outcomes generally represents a winning set or combination of icons as displayed arranged in selected positions. After the player selects one or more pay line outcomes, the player activates the electronic reels 50, 52, 54, 56 and 58 by engaging the play activation interface which in this case is by pulling the lever 34 or pressing the spin reels button shown on the screen 32. The play activation mechanism is an input device in electronic communication with the controller 12. Each of the reels (50-58) include a series of icons. In this embodiment, the reels are 50-58 are simulated to spin on the display 32 until the controller 12 randomly stops the reels 50-58 individually, such that when all the reels 50-58 stop spinning, a base game outcome set is created and an associated icon combination is displayed on the screen 32.

The processor 14 uses a random number generator (not shown) to randomly generate the base game outcome set from a set of possible stop outcomes stored in the controller 12 and/or processor 14. The random generator generates a base game set of outcomes during the base game play sequence. This set of outcomes is displayed on the screen display 32. In the present embodiment, the base game outcome set generally comprises an arrangement of fifteen icons, which is displayed on the screen display 32 in a grid line format of three rows and five columns.

The randomly generated base game outcome set is compared to a series possible outcome sets stored in the memory of the processor 14. The series of possible outcome sets comprise one or more winning pay line outcome sets, one or more first bonus round triggering outcome sets, and one or more second bonus round triggering outcome sets. Notably, it is contemplated that other additional outcome sets for triggering other events on the gaming device 10 can exist without departing from the scope of the present invention.

The winning pay line outcome sets represent winning combinations of outcomes that when matched in accordance to arrangement, the player is credited a value associated with the associated pay line credit value. When one or more of the winning pay line combinations match the base game outcome set, the player is credited a predetermined value of credits for each matching pay line combination that matches the outcome set.

Based the comparison of the base game outcome to the possible outcome sets, the player wins credit values associated with the winning pay line outcome, loses credits based on value of the player's bets that do not match the winning pay line outcomes, or the outcome set matches a triggering outcome set for a first bonus round sequence or second bonus round sequence.

In one embodiment of the present invention, at the start of the base game play sequence, the BIG CASH BACK METER™ starts at a zero value. Values for the BIG CASH BACK METER accumulate as the player plays and loses. In this embodiment, the meter continues to accumulate and returns to zero only when the player ends game play completely or when the player wins the value of credits in the cash back meter by generating one of the triggering events through game play and triggers the big cash back.

In another embodiment of the present invention, the controller 12/processor 14 calculates the value of credits and/or money wagered and lost during the base game play sequence. The values of the total bet is displayed on the bet meter and a percentage of value of lost credits is displayed on the lost meter or BIG CASH BACK METER” the meter increases by the value of credits bet for each pay line that did not win. In this example, if a player wagers an amount such as 100 on each of 5 lines totaling 500 dollars and only one of those five lines is a winning combination, then the player is credited in the credit meter for the winning combination and at the BIG CASH BACK METER™ at the player is credited for the value of lost credits, which in this example would be 400 dollars. In another embodiment the player is credited at the BIG CASH BACK METER™ for a predetermined percentage of the value of credits wagered.

In one embodiment of the present invention, the loss meter 44 and processor 14 act as a self-progressive for the gaming device 10, wherein the cumulated lost wager values are calculated and applied to a mathematical formula used to generate base game play outcomes. In this case, the lost wager calculated values are inserted into the random number generator mathematical calculation and used to determining future base play sequence pay line and winning outcomes.

For the wager values on pay line outcomes that do not match any of the preferred or winning outcomes, the player then loses that wager value and a percentage of lost credits values are credited to the loss counter or BIG CASH BACK METER™.

After the base game outcome set is generated that outcome set is also compared to the first bonus round triggering outcome set stored by the processor 14. In the event that the base game outcome set matches the first bonus round triggering outcome set, the game enters a first bonus round. In the present embodiment, the first bonus round triggering outcome set comprises three or more scattered Payback hog coins appearing on the screen display. Other triggering outcome sets are contemplated without departing from the scope of the present invention.

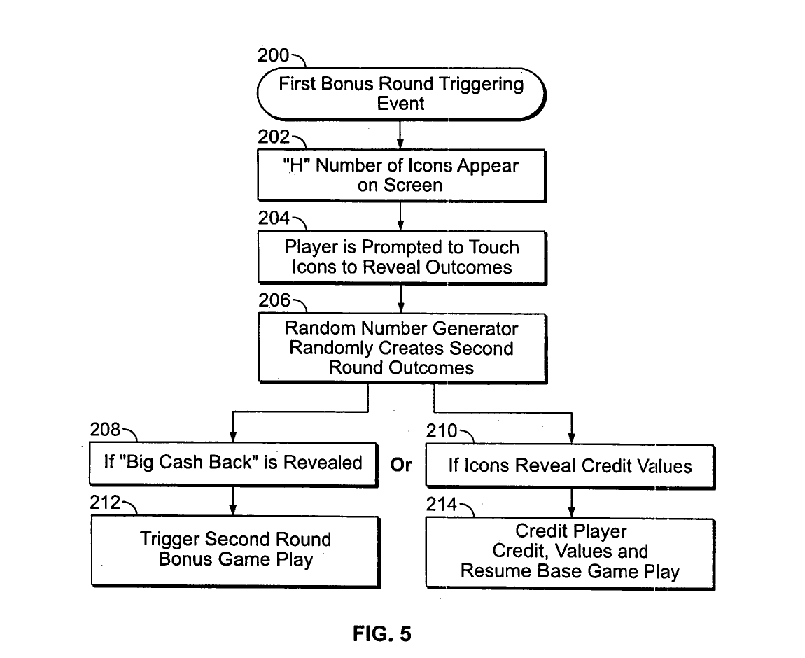

Once the game enters a first bonus round mode a combination of icons are displayed on the screen display. In accordance with this embodiment, during the first bonus round sequence, three or more scattered icons are shown flashing and/or spinning. In the present embodiment each coin icon has a front side and a back side. The player is then prompted to activate the icons by touching the icons at the location on the screen, which then reduces the spinning action and generates a first bonus round outcome. As shown in FIG. 5, in the first bonus sequence, a series of outcomes are randomly generated by the controller 12. In this embodiment, when the outcome displays icons display two front sides and a back side, a credit amount is revealed and the player is credited the value displayed and returned to the primary play sequence.

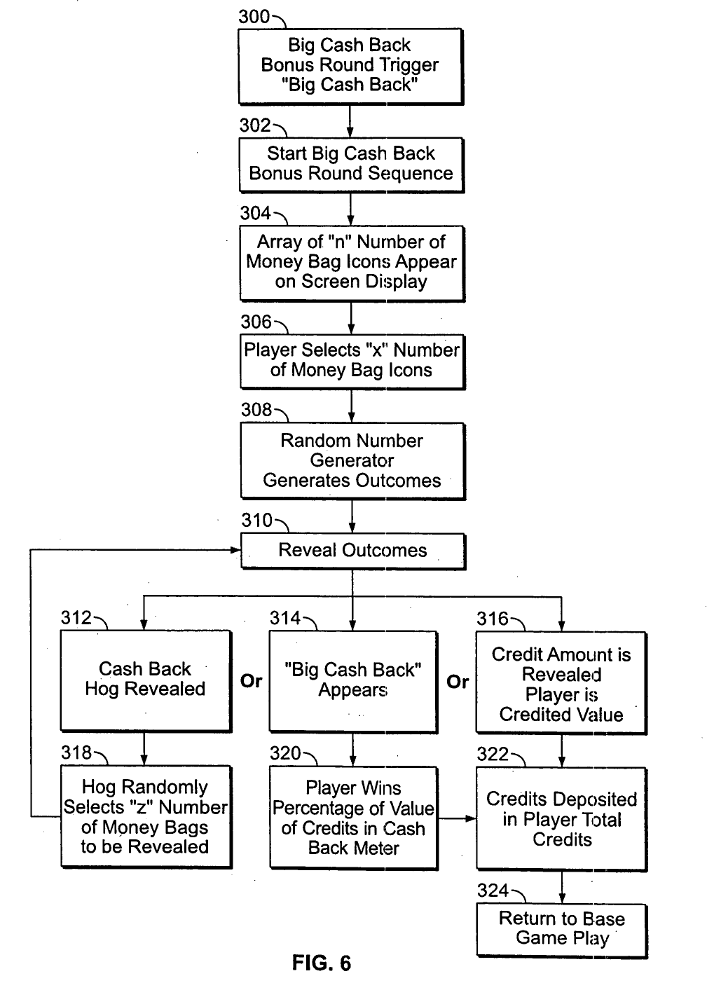

Referring now to FIG. 6, the second bonus round play sequence is triggered when the set of outcomes generated by the basic game play sequence or the first bonus round sequence matches the second bonus round triggering outcome set. In the present embodiment, the bonus round play sequence is triggered when the second trigger outcome play set display icons comprising “BIG CASH BACK” is displayed on three of the reels (50-58) on the screen display 32. It is contemplated that the icons “BIG CASH BACK” are displayed sequentially. Notably, other second bonus round triggering outcome sets can exist without departing from the scope of the present invention.

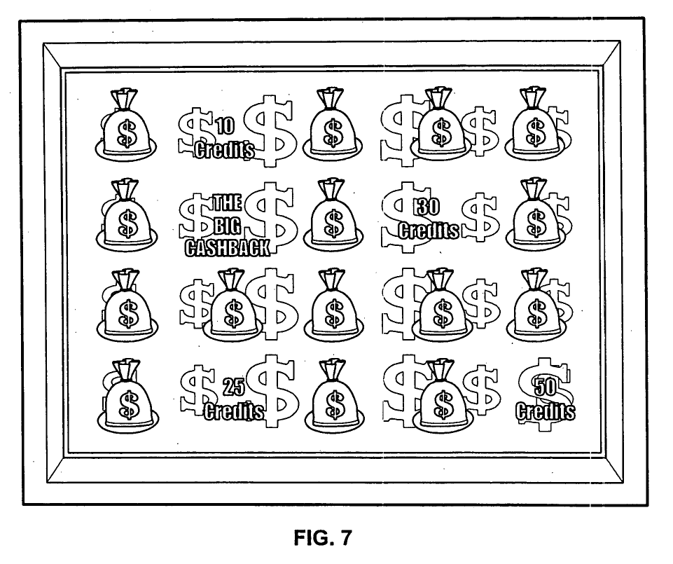

In one embodiment, during the second play bonus sequence, the player has the opportunity to win a value equal the value displayed on the loss meter 44, as known as THE BIG CASH BACK METER™. The icons are arranged in an array of rows and columns enabling the player to view all of the icons at once. In accordance with the present invention, the icons are money bags, however, it is contemplated that the icons can be any symbol and/or indicia, without departing from the scope of the present invention. As shown in this embodiment, the second bonus feature includes an array of icons shown as twenty money bags arranged on the screen display, for the player to select from as shown on FIG. 7.

FIG. 7 shows an example of the screen display 32 of the second bonus sequence. As shown, a series of money bag selections for the player to choose. The player selects the money bag, by pressing the screen display at the location of the selected bag. In accordance with the present invention, the player selects a predetermined number of bags. Selection of the bags reveals an outcome. The player however, does not know the outcome until all of the selections are made. In the present embodiment, the player selects four bags to reveal the hidden outcomes, which can be monetary values or other icons. Notably, it is contemplated that a player may select any variable number of bags without deviating from the scope of this invention.

During the selection process, the screen display detects the touch of the player at the icon location. Upon touch, the icon reveals a credit amount in which the player will be credited. After all four picks have been made, the bags simulate an opening effect which reveals either a credit amount that will be added to the credit amount total or the player may find an icon, such as the THE BIG CASH BACK™ symbol, in which the player will be awarded the credit values displayed by the loss meter 44.

In another scenario, an animated character, such as a CASH BACK HOG™ will jump out of one of the bags that the player chooses, and proceed to randomly select a “z” number of bags, thereby revealing additional outcomes, which may be additional credit values, THE BIG CASH BACK symbol and other icons associated with the game. The player then exits the second bonus game sequence and returns to the basic game format. The player resumes play until he decides to cash out and receive the value of the credits displayed in the credit counter. Upon ending game play, the game resets and the credit counter and loss counter return to a zero value for the next player.

While the present invention has been described in connect with what is presently considered to be the most practical and preferred embodiments, it is to be understood that the invention is not limited to the disclosed embodiments, but on the contrary is intended to cover various modifications and equivalent arrangements included within the spirit and scope of the claims. It is thus to be understood that that modifications and variations in the present invention may be made without departing from the scope of the novel aspects of this invention as defined in the claims, and that this application is to be limited only to the scope of the invention.

The invention is claimed as followed:

1.) A gaming device, comprising:
a loss counter for cumulating the values lost during a first play sequence;
a first bonus play sequence comprising a first selection group having a plurality of first selections, wherein the outcome of the first selections yields an award; and,
a second bonus play sequence comprising a second selection group having a plurality of second selections, wherein the outcome of the second selections enable a user to win the cumulated values of the loss counter.

2.) The gaming device of claim 1, wherein the first selection group comprises a series of icons activated and deactivated by the player's touch to a display screen.

3.) The gaming device of claim 1, wherein the first selection group comprises predetermined award values and outcomes enabling the player to enter the second bonus play sequence.

4.) The gaming device of claim 1, wherein the second bonus play sequence comprises as series of icons concealing randomly generated values.

5.) The gaming device of claim 1 wherein the loss counter serves as a progressive such that the values generated by the loss counter are considered in determining future outcomes

6.) The gaming device of claim 4 wherein the series of icons reveal randomly generated values enabling the player to win values equal to that accumulated on the loss counter.

7.) The gaming device of claim 6 wherein the series of icons comprise an array of twenty icons displayed on the video display enabling player selection of said icons.

8.) The gaming device of claim 7 wherein said icons are money bags concealing randomly generated values.

9.) The gaming device of claim 8 wherein one of said concealed values is equal to the credit value of the loss counter

10.) The method of operating a gaming device, said method comprising;
(a) displaying a plurality of icons representing selectable choices;
(b) enabling a player to select a series of pay line scenarios;
(c) counting the values of cumulative loss credits;
(d) providing a first bonus sequence;
(e) generating a series of outcomes in the first bonus sequence wherein the outcomes determine values won and whether the player enters a second bonus sequence;
(f) providing a second bonus sequence having a selection group;
(g) causing the selection from the selection group

11.) The method of operating a gaming device, said method comprising
(a) displaying a series of icons in a selected grid-line format on a screen display;
(b) prompting a user to bet on one or more pay lines;
(c) assigning a credit value to user's bet and recording said credit value on a processor;
(d) prompting the user to initiate a first play sequence;
(e) randomly generating an outcome set in the series during said first play sequence using said processor and displaying said outcome set on said screen display;
(f) comparing said first outcome set to a series of winning pay line sets, a first bonus round triggering set and a second bonus round triggering set, wherein if said first outcome set matches said one or more of said winning sets, providing said player with a credit value equal to a predetermined amount associated with each of the winning sets;
wherein if said first outcome set matches one or more of the first bonus outcome sets, initiating a first bonus round play sequence,
wherein if said first outcome set matches one or more second bonus outcome sets, initiating a second bonus round play sequence,

12.) The method of claim 12, wherein if said first outcome set does not match any of the first winning pay line sets, first bonus round outcome sets and second outcome groups, then crediting said player the value of lost credits wagered multiplied by a predetermined percentage and displaying said value on a loss meter and initiating a second play sequence.
